(19) United States
(12) Patent Application Publication
(10) Pub. No.: US 2010/0205091 A1
(43) Pub. Date: Aug. 12, 2010

(54) AUTOMATED PAYMENT TRANSACTION SYSTEM

(75) Inventors: Joseph M. Graziano, Tualatin, OR (US); David G. Pease, Portland, OR (US); Karla Friede, Tigard, OR (US); Tana Law, Tigard, OR (US)

Correspondence Address: MARGER JOHNSON & MCCOLLOM, P.C., 210 SW MORRISON STREET, SUITE 400, PORTLAND, OR, 97204, US

(73) Assignee: Zevez Payments, Inc., Portland, OR (US)

(21) Appl. No.: 12/578,343

(22) Filed: Oct. 13, 2009

Related U.S. Application Data
(63) Continuation-in-part of application No. 10/972,228, filed on Oct. 22, 2004.

(51) Int. Cl. G06Q 20/00; G06Q 40/00

(52) U.S. Cl. 705/40

(57) ABSTRACT

A secure system for using credit card accounts to cause payment into an account of said vendor on behalf of said vendor.

### CROSS-REFERENCE TO RELATED APPLICATIONS

This application is a Continuation in Part of U.S. application Ser. No. 10/972,228, filed on Oct. 22, 2004, and with respect to material not originally disclosed in this parent non-provisional application, also claims the benefit of U.S. Provisional Application Ser. No. 60/196,321, filed on Oct. 15, 2008.

### BACKGROUND OF THE INVENTION

Businesses and consumers (borrowers) use credit cards to purchase billions of dollars in goods and services annually. Credit cards are issued to borrowers by financial institutions (lenders) such as banks or credit unions and include a typically sixteen-digit card number to link the card to a credit account for the borrower. The borrower is thus able to present the credit card to a merchant so as to make a purchase, the vendor receives payment from the lender using the card number, and the borrower's account is debited for the purchase. When receiving a credit card from a lender, the borrower agrees to contractual terms that obligate the borrower to repay not only the amounts that the borrower charges to the credit account, but also interest due on unpaid account balances, penalties for any late payments, collection costs for recovering defaults, etc. In addition to credit cards, purchasers may also use charge cards, such as American Express, or debit cards, in which a purchaser can link a card to the purchaser's checking or savings account at the financial institution that issued the card.

When deciding to issue a credit card to a borrower, as well as fixing the credit limit for the account associated with the card, a lender will naturally want to consider that borrower's creditworthiness, including both the borrower's financial ability to promptly repay amounts borrowed and the past inclination of the borrower to do so. Though related, these two factors are not mutually determinative of each other, as a person having the financial means to promptly repay amounts borrowed may not have the personal responsibility to do so. To facilitate a lender's ability to assess the creditworthiness of a prospective borrower, lenders report payment history for existing borrowers to credit reporting agencies that compile credit histories and compute credit scores for individual borrowers. A borrower's credit score and credit history are then provided to lenders when a borrower seeks additional credit.

Their convenience has made the use of credit cards, debit cards, and charge cards ubiquitous in a modern economy. This widespread use of credit cards is not without drawbacks, and in particular, credit cards are often used to make fraudulent purchases. Moreover, fraudulently obtained credit card information may often be used to mimic the identity of a person with good credit history so as to obtain additional credit, such as an additional credit card, an auto loan, etc. Subsequent defaulted credit transactions using another person's identity then reduce a victim's credit history and credit score, which can be very difficult to repair.

Security measures to prevent the fraudulent use of credit cards are not as effective as desired. Historically, credit cards have been presented in person when making a purchase, and the presenter's photo identification could be compared to the name on the card. In recent times, however, credit cards have been used to make electronic purchases over the Internet, or to purchase items over the telephone. This increases the potential for credit card fraud, not only in that purchases may be made with knowledge of a credit card number, alone, but also in that it becomes easier to fraudulently obtain those numbers. For example, sophisticated identity thieves may mimic a website of an online retail store, a website of credit card issuing bank, etc. so as to obtain credit card information from consumers. Often, traffic is directed to these counterfeit websites by mass e-mails, which invite credit card holders to visit those web sites so that consumer credit card data may be compiled and sold. Alternatively, and to lend credibility to such messages, an alternate phone number will be given by which the recipient may purchase the desired goods or services over the telephone, but the telephone number is again to a counterfeit location that mimics that of the real vendor.

Fraudulent purchases later made with information gathered using these techniques are almost impossible to prevent, even with such recent security measures such as automated verification of the expiration date on the credit card and/or a three digit security code printed on the back of the card. These security measures attempt to ensure that the purchaser possesses the card used to complete the transaction, but once such measures become commonplace, purchasers expect to be requested that information, and will willingly divulge that information to counterfeit websites under false pretenses.

What is desired, therefore, is an improved automated method of processing credit card transactions that reduces the risk of the fraudulent acquisition of a borrower's credit card information.

The foregoing and other objectives, features, and advantages of the invention will be more readily understood upon consideration of the following detailed description of the invention, taken in conjunction with the accompanying drawings.

### BRIEF DESCRIPTION OF THE SEVERAL VIEWS OF THE DRAWINGS

FIG. 1A shows a first example of an automated payment transaction system including a payor host capable of capturing a payment transaction to a payee and submitting that transaction on behalf of those two parties.

FIG. 1B shows an example of payment transaction data that is processed and submitted by the host shown in FIG. 1.

FIG. 2A shows a second example of an automated payment transaction system in which a payor host submits a captured payment transaction to an Internet gateway.

FIG. 2B shows a third example of an automated payment transaction system.

FIG. 2C shows a fourth example of an automated payment transaction system.

FIG. 3A shows an exemplary local payor host device and an optional remote device.

FIG. 3B shows a transaction system, implemented by the payor host device of FIG. 3A, that is capable of completing automated payment transactions in accordance with FIGS. 1A-2C.

FIG. 3C shows an exemplary subsystem of the transaction system of FIG. 3A.

FIG. 3D shows a specific embodiment of the disclosed transaction system performed by the local and remote computing devices of FIG. 3A.

FIG. 4 shows a specific embodiment of the transaction system of FIG. 3A used in conjunction with a stand-alone accounting program.

FIGS. 5-9 show respective screens in an exemplary payor host performing an embodiment of the disclosed payment transaction system.

### DETAILED DESCRIPTION OF PREFERRED EMBODIMENT

In this specification, the term “credit card” should be understood to encompass not only those cards that are linked to revolving account of credit, such as Master Card, VISA, and Discover, but also to charge cards such as those issued by American Express as well as debit cards that are linked to a checking or savings account of a commercial institution from which the cardholder conducts banking transactions. In addition, the term “credit card” should also be understood to include pre-paid credit cards, where appropriate. In addition, the following terms will be accorded the meanings that respectively follow them, which should be understood by those familiar with the art. These meanings are provided to facilitate understanding of the specification by those unskilled in the art, as well.

ABA (American Bank Association) Routing Number—a nine digit number used to identify individual branches of financial institutions that participate in ACH transactions. The first two digits of this number indicate the Federal Reserve region of the participating branch.

Acquiring Bank—A financial institution that accepts credit card payments for the products or services on behalf of a merchant, against a line of credit for the merchant. A merchant account number associates accepted credit card transactions with the merchant's line of credit. To illustrate, a merchant submits a credit card payment authorization to its acquiring bank, which then draws the funds against the merchant's line of credit so as to make the funds immediately available to the merchant, and prior to the Acquiring Bank's receipt of payment from the customer's credit card providing bank. When the acquiring bank does receive payment from the providing bank, the merchant's line of credit is credited with the amount.

Address Verification Service (AVS)—An automated service that verifies a billing address submitted by a purchaser in a card-not-present transaction, e.g. an online purchase.

Authorization Code—A six-digit code returned from the Electronic Verification System when a merchant processes a credit card transaction to ensure that a customer has funds available on a credit card account to cover the amount purchased.

Automated Clearinghouse (ACH)—a system in which electronic debit transactions are transferred between participating financial institutions. ACH was instituted to handle high volumes of relatively low debit amount transactions, and has been analogized to an electronic check. The ACH system sorts the processed transactions daily, by each of the fmancial institutions involved in the transactions, and applies credits and debits to the accounts of those institutions accordingly.

Batch—a collection of a merchant's credit card transactions over a specified interval, typically daily. Credit card transactions are batched over that interval and submitted to the merchant's acquiring bank for simultaneous processing, Batches are usually submitted automatically by a device such as a Point-of-Sale (POS) terminal or an Internet Gateway. Each batch is assigned a Batch ID by the acquiring bank. The batch ID is associated with each credit card transaction in the batch.

Card Present/Card Not Present—Two alternative descriptions of a credit card transaction. In a card present transaction, such as when a customer pays for a meal at a restaurant, the credit card and the holder of the card are both present simultaneously. In a card-not-present transaction, such as an online sale or a telephone sale, as well as most business-to-business transactions, the merchant does not physically verify that the customer possesses the credit card.

Chargeback—A credit card transaction where amounts previously charged to a credit card are credited back to the holder's account. Typical instances for chargeback transactions are when the goods or services are not provided, charges were made fraudulently, or mistaken amounts were initially charged.

Confirmation—A communication sent to a merchant on a periodic basis that confirms batch deposits.

Card Validation Code (CVC)2 or Card Verification Value (CVV)2—A three digit code imprinted on the back of a credit card, following the signature line. The CVC2 code is used in Card-Not-Present transactions as a measure to validate that the purchaser has the card at the time of the transaction. The CVC2 code is present on the magnetic stripe of the card. Neither the merchant and the acquiring bank, nor the issuing bank are to store the CVC2 code for a submitted transaction. In an Internet purchase, the CVC code is to be encrypted.

Electronic Clearinghouse, Inc. (ECHO)—A third party processor used by acquiring banks to process credit card transactions on their behalf.

Host—a computer system that operates a POS terminal, an Internet Gateway, or other software that captures credit card transaction information and submits it to an acquiring bank.

Interchange fees—fixed rates set by MasterCard, Visa, etc, varying by merchant industry, assessed to a merchant for processing a credit card transaction.

Internet Gateway—a virtual Point-of-Sale (POS) Terminal used by an on-line merchant to capture credit card transaction information, batch them, send batches to the merchant's Acquiring Bank, and receive confirmation information regarding submitted batches. In Internet Gateway is usually hosted by a third party, which allows an Internet merchant to either log on manually using a secure code, or allows the merchant's shopping cart to log on securely. Some acquiring banks operate their own payment gateways.

Issuing Bank—A financial institution that issues a credit card to a borrower according to a cardholder agreement. The Issuing Bank, after receiving transaction data through ACH pays a merchant's acquiring bank the purchase amount of goods or services bought with a credit card of the issuing bank.

Merchant—Any entity, such as a retailer, wholesaler, etc. who meets the criteria of MasterCard and Visa and agrees to accept payment by credit card for goods and services.

Merchant Account—The line of credit that a merchant holds with an acquiring bank. Using this line of credit, the acquiring bank exchanges funds with issuing banks on behalf of the merchant, and pays the merchant for the net balance of their daily payment card activity: gross sales, minus reversals, interchange fees, and acquirer fees, which are an additional markup, added to interchange fees, by the acquiring bank.

Plural Interface Processing (PIP)—The ability of a POS terminal or Internet gateway to process American Express transactions directly through the American Express network. This saves merchants from paying fees to their acquiring bank.

Point of Sale (POS) Terminal—An electronic device used by a merchant to capture credit card transactions information, batch them, sent batches to the merchant's Acquiring Bank, and receive confirmation information regarding submitted batches. It is typically a stand-alone deice that allows a merchant to swipe or key-enter a credit card's information as well as additional information required to process a credit card transaction.

Reconciliation—An exchange of information between two parties to reach agreement on the respective balances owed between them.

Terminal ID (TID)—A number assigned to a POS terminal or Internet gateway that uniquely identifies the merchant's equipment in networked transactions.

As noted previously, existing electronic systems that process credit card transactions have inherent vulnerabilities that may be exploited so as to fraudulently obtain and use a debtor's credit card data. The present inventors realized that this vulnerability arises from the fact that the existing credit card transaction system requires that a credit card holder, wishing to purchase a merchant's goods or services, must reveal to a merchant sensitive credit card data, including at a minimum the credit card number, the expiration date, and the name of the holder. Moreover, if the credit card is processed using a card-not present transaction, the holder will also reveal the CVV2code, the holder's billing address, and potentially any other information contained in the magnetic stripe of the credit card that is used to electronically verify that the purchaser has the credit card.

With this in mind, the present inventors realized that any notable improvement in the existing credit card processing system should preferably involve the cardholder submitting the transaction to the merchant's acquiring bank, either directly or indirectly, without the need to reveal any credit card information to the merchant.

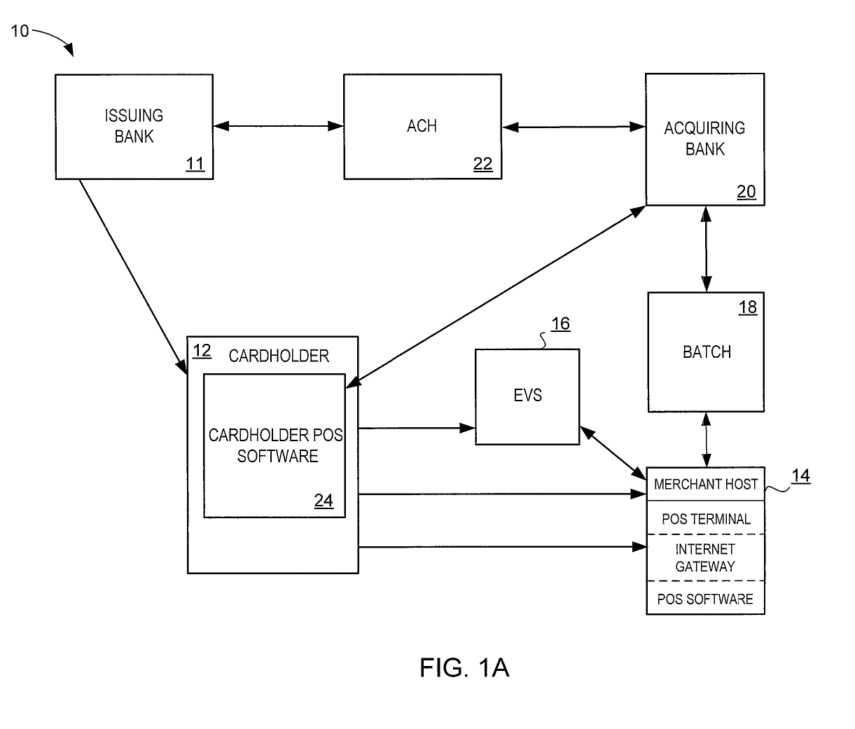

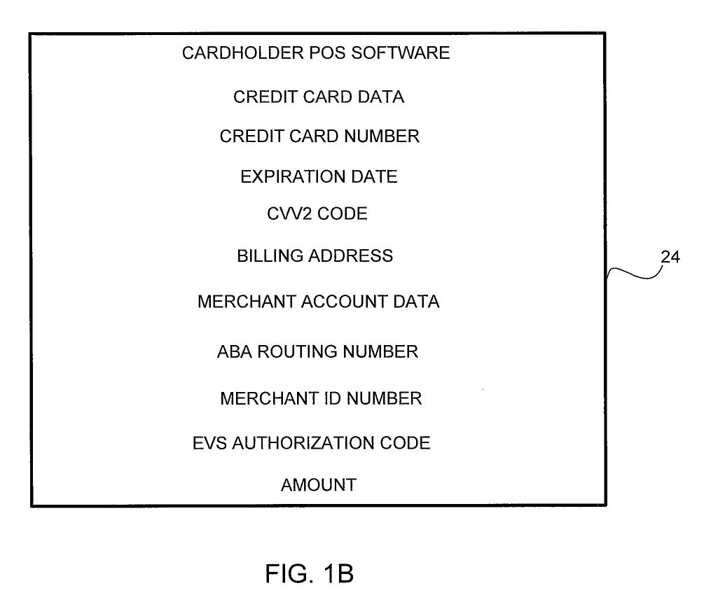

FIG. 1A shows a system 10 that optionally incorporates such an improved system. Typically, an issuing bank 11 will issue a credit card to a cardholder. The credit card may be any one of a variety of credit types, such as MasterCard, Visa, American Express, Discover, etc. In an existing credit card transaction, such as one that occurs when purchasing goods at a restaurant, for example, the card holder physically presents the card to the merchant, who has a host computing system 14, such as a POS terminal that is typically located near a cash register. The card is swiped and the data in the magnetic stripe is optionally transmitted to an Electronic Verification System (EVS) 16 which returns a one-bit approval/disapproval code after checking to see whether there are sufficient funds on the card to pay for the proposed purchase. If the purchase is approved, the EVS 16 may also include a further six digit code to attach to the transaction, and reserve the amount of the purchase against the cardholder's remaining balance. The six digit code may be used, for example, to attach further costs, such as a tip, to the transaction.

The POS terminal 14 stores all approved, captured transactions over a specified interval and submits the group of stored transactions to an acquiring bank 20 as a batch 18 at the end of that interval. The electronic batch 18 of transactions submitted to the acquiring bank 20 is often followed by paper copies of authorizations for the purchases, i.e. a signed authorization to charge the credit card. Upon receipt of the batch 18, the acquiring bank 20 will assign an identification number to the batch, which in turn is associated with every credit card transaction in the batch. The acquiring bank 20 then extends to the merchant an amount equal to the value of the purchased goods, minus any associated interchange fees, acquiring fees, reversals etc., drawn on a line of credit until the acquiring bank 20 is compensated by the issuing banks 11 of the respective cardholders.

Although the foregoing procedure was described with respect to an electronic transaction, that procedure is also used with respect to paper transactions, i.e. when a merchant makes a carbon imprint of a credit card. Also, although the foregoing explanation of the submission of credit card data for a transaction between a cardholder to a merchant, and in turn to an acquiring bank 20 described a POS terminal 14, the merchant may have instead used an Internet Gateway, POS software, or a keyed transaction with credit card data received over the telephone. In any of those instances, there will likely be no paper authorization of the credit transaction.

The Acquiring Bank 20 usually submits the individual transactions to the respective Issuing Banks 11 through the ACH system 22, which normally takes only a day or so. The issuing bank 11 will then debit the credit account of the cardholder for the amount of the purchase, which will be reflected in the next statement sent to the purchaser.

FIG. 1A also shows an alternate, novel system for capturing and submitting a credit transaction between a cardholder and a merchant. The cardholder 12 may operate a purchaser or payor host 12 that includes POS software or other technology capable of capturing a credit transaction and submitting it to an acquiring bank 20. For example, as illustrated in FIG. 1B, the payor host 12 may capture a credit card transaction by receiving from the merchant an identifier for the merchant's acquiring bank and the merchant's account at the acquiring bank through which credit card transactions are processed. This identifier will typically include the same identifier used by the merchant's host 14 when submitting batch transactions, i.e. the merchant ID number. Because a merchant host 14 may be hard coded to directly provide transaction data to its acquiring bank, the payor host 12 may also capture an identifier for the acquiring bank itself, such as the bank's ABA routing number or any other identification of the merchant's acquiring bank. The payor host 12 will also capture the particular data for the credit card that the payor desired to use to complete the transaction, such as the credit card number, the

CVV2 code, etc, as well as the amount of the payment. The payor host 12 may also preferably have the ability to obtain an EVS authorization code from the EVS 16 and attach it to the captured transaction.

Once the payor host 12 has captured all relevant data for the transaction, including any needed authorization code, the payor host may automatically submit the captured transaction to the acquiring bank 20 on behalf of the merchant The payor host 12 may also send the captured transaction to the merchant for verification of payment, along with any code attached to the transaction by the acquiring bank 20. For example, the acquiring bank 20, after receipt of the captured transaction, may assign it the same batch 18 number as that used for the captured transactions by the merchant host 14 for that day. In this manner, the merchant, upon receipt of a captured transaction from the payor host 12, which includes an EVS code, and/or the proper batch code, will know that payment has been made.

It should again be understood that the foregoing example of a cardholder submitting a transaction to a merchant's acquiring bank, on behalf of the merchant, could also be completed using a paper authorization. For example, the merchant host 12 may be capable of generating a paper authorization form and sending that form to the acquiring bank. This paper authorization may be used in addition to, or as a substitute for, an electronically submitted transaction. A submitted paper authorization will typically be of benefit to the merchant in that the merchant may receive a lower interchange fee for the transaction. Moreover, it should be understood that the payor host 12 should preferably be unable to submit a chargeback transaction to the merchant's acquiring bank. A chargeback transaction can be distinguished as being received by the payor host 12 through a TID assigned to the payor host 12, or if none is present, may be ignored by the acquiring bank 20 on the basis that the received transaction will not include the TID assigned to the merchant's POS terminal.

It should also be understood that, although the foregoing example of a payor host 12 described POS software that captured and submitted a payment transaction, the payor host 12 could instead use an Internet Gateway, a keyed transaction, etc. Moreover, the payor host 12 may submit captured transactions to third party intermediaries such as ECHO or ACH rather than directly to the acquiring bank 20. In this vein, the submitted payment transactions could involve, rather than credit card payments, check payments or any other form of payment that flows through ACH.

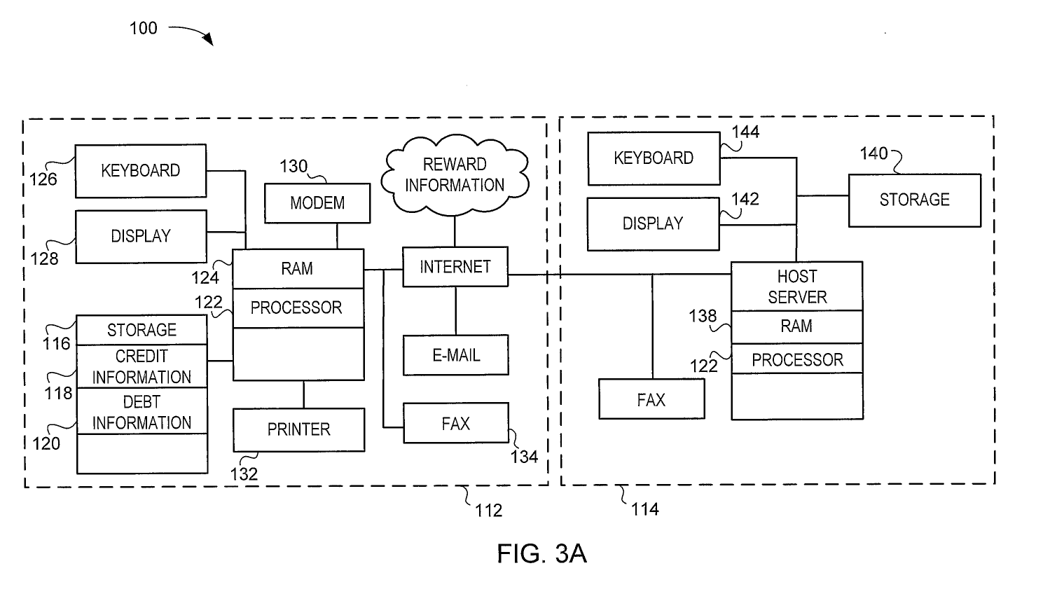

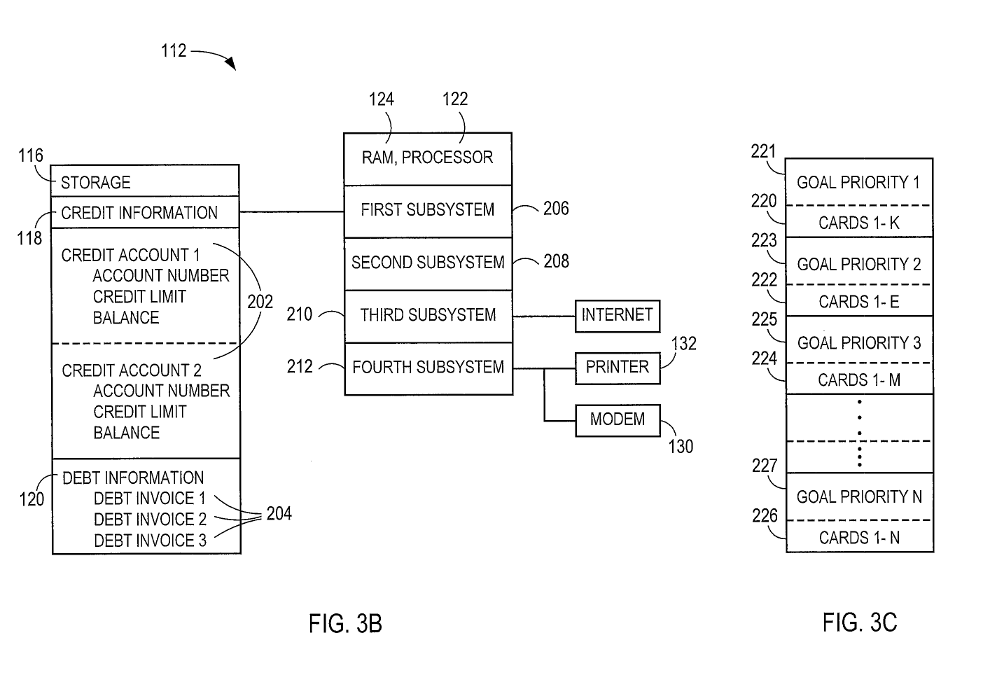

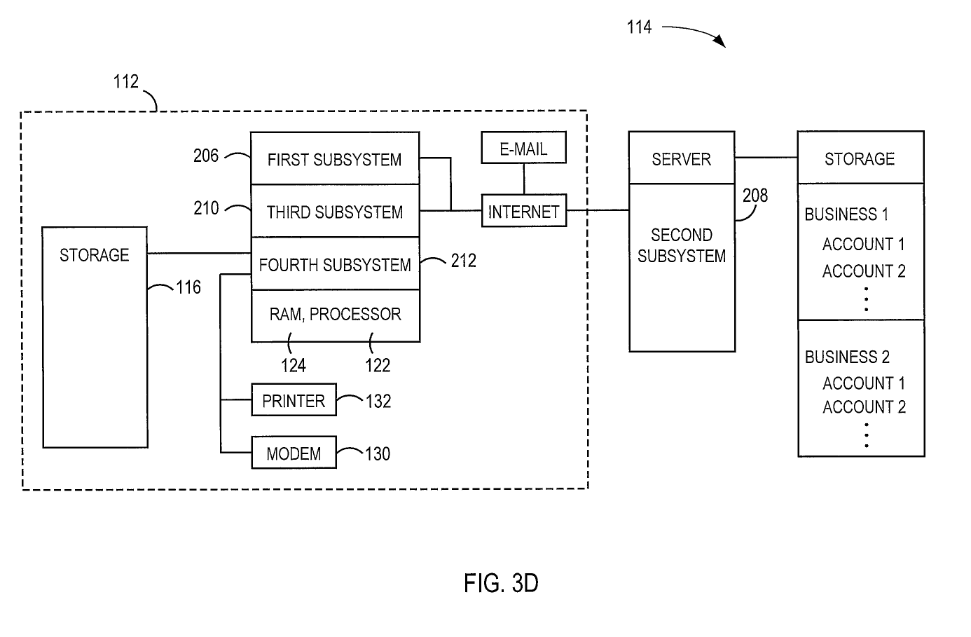

The payor host 12 is preferably capable of jointly processing multiple user-specified transactions on behalf of the cardholder. In other words, a cardholder may specify or confirm multiple independent payments to one or more vendors, and the payor host 12 processes those transactions after a single instruction. Furthermore, the payor host 12 is preferably capable of automatically, jointly allocating payment amounts, from plural credit cards, to multiple accounts payable to respective vendors owed by the cardholder. In other words, the payor host 12 automatically assigns payment amounts from among plural credit cards, to plural accounts payable. For example, referring to FIGS. 3A-3D, the payor host 12 may implement a transaction system 110 comprising a local computing device 112 and an optional remote computing device 114. The transaction system 110 is capable of jointly processing multiple payment transactions so as to allocate payments among a plurality of payment instruments, such as checks, credit cards, etc. The disclosed transaction system 110 is also capable of allocating payments among a plurality of credit cards, which each include rewards for the use of the respective credit cards, in a manner that maximizes a user-defined reward benefit function.

In this embodiment, the payor host 12 may include a local computing device 112 that preferably includes storage 116 for storing credit information 118 for at least one credit card account and debt information 120 for at least one vendor. The local computing device 112 also preferably includes a processor 122, Random Access Memory (RAM) 124, input devices such as the keyboard 126 and/or a mouse, a visual display 128, a modem 130 or other device capable of communication with other systems through the Internet or otherwise, and a printer 132. Some embodiments of the disclosed system may employ a fax machine 134. If a payor host 12 is connected to a remote computing device 114, it may include its own processor 136, RAM 138, display 142, keyboard and/or mouse 144 and storage 140. Any remote computing device 114 provided with the payor host 12 preferably includes a connection to the Internet to facilitate communication between the local computing device 112 and the remote computing device 114.

Generally speaking, the disclosed payor host 12, in this embodiment, is capable of retrieving selected credit information 118 and debt information 120 from storage 116 and allocating amounts due vendors among available rewards cards in a manner that maximizes the reward benefits obtained. The credit information 118 preferably includes a reward value associated with each credit card account stored in the storage 116, and these respective reward values are used to allocate debts among the stored credit card accounts. The connection to the Internet may be used to access the remote computing device 114 so as to periodically update any or all of the credit information 118, the debt information 120, current reward values for the respective credit card accounts, software upgrades, or any other data useful to the local computing device 112 on the payor host 12.

In one embodiment, the remote computing device 114 may be a service provider that facilitates the payments from payors to vendors. For example, the remote computing device 112 may be a repository of data indicating the type of payments accepted by specific vendors, which may be accessed by the payor host 12. Thus, if a particular vendor whose records are stored in the storage 116 of the payor host 12 decides to accept a particular type of credit card, such as Visa, Mastercard, American Express, etc., the service provider 114 may alert any payor host who purchases from such a vendor using any appropriate means, such as an e-mail alert, an update alert viewable in the payor host 12, or simply automatic updates that activate selectable fields of a user interface, add information to drop-down menus of a user-interface, etc.

A service provider of the remote computing device 114 may also offer services such as updating rewards values, providing software updates that provide new functionality, may act as an intermediary that obtains verification codes 16 for credit transactions, submit credit authorizations on behalf of a payor to an acquiring bank or intermediary such as ACH, store merchant account numbers of vendors, process electronic fund transfers, or any other service of use to payors of vendor invoices when using the payor host 12. The service provider of the remote computing device 114 may also negotiate on behalf of one or more payors of vendor invoices to persuade vendors to accept credit card payments, electronic funds transfers, or also negotiate interchange rates payable to issuing banks and/or credit card institutions such as Visa and American Express when using a payor host 12. The service provider of the remote computing device 114 may also operate an Internet gateway or other transaction-capturing mechanism to facilitate payments from payors to vendors on invoiced accounts. These examples are intended to be illustrative of the types of services potentially provided by a service provider of the remote computing device 114, and should not be read as limiting.

From the foregoing discussion, the flexibility of the system 10 is readily appreciated. Existing mechanisms by which payment is made on invoiced accounts requires piecemeal treatment of individual invoices. For example, while existing invoice payment systems may permit checks to be produced and mailed to individual vendors, such payment systems do not permit invoices to be paid by credit cards, even if the vendors accept them. Rather, to make those credit card payments, a payor typically must contact the vendor so that the transaction may be either completed by joint involvement of the payor and vendor, e.g. on a vendor's or third party's web site (PayPal), or the provision of credit card data to the vendor so that the vendor may capture and submit the transaction on behalf of both parties. Similarly, electronic funds transfers require that the payor either contact the vendor to obtain or give account information to arrange for an exchange of funds between bank accounts, or contact a bank that has account information for the vendor on file.

In contrast, the disclosed system 10 and its described variants permit the joint processing of invoices of all transaction types. If a vendor accepts credit cards, the payor may unilaterally initiate and complete a particular credit card transaction according to terms completely controlled by the payor, e.g. payment date, payment amount, etc and without consultation or action by the vendor. A payor may split an invoice among multiple credit cards to maximize benefits associated with the credit account such as rewards, floats, interest rate reductions, etc. A payor may make partial payment on an account if funds or credit is not available for the full amount or if there is a dispute over the amount due. If payment is to me made in full or in part by electronic funds transfer or by check, the system 10 is again able to initiate, process, and complete the payment unilaterally. These advantages are of substantial benefit to payors of vendor invoices.

The term “reward value”, as mentioned above, should not be understood as requiring a numerical quantity or implying only a single value. For example, the disclosed device 112 may associate a reward value with each stored credit card account that is nothing more than a ranking among all stored accounts, such that vendor debts are first allocated to the highest (or lowest as the case may be) ranked card and sequentially to the next ranked card, etc. The reward value associated with each respective credit card accounts could be the actual incremental benefit, in dollars (or any other currency) received for each dollar charged on the account. Alternatively, the “reward value” could be a number of values or quantities. For example, where a given reward card gives double points for charges to a particular vendor stored in the storage 116, the “reward value” may comprise a number of indicators, values, and/or quantities, indicate respective vendors and an incremental reward benefit associated with each vendor.

FIG. 3B shows an embodiment comprising the local computing device 112 having storage 116 storing credit information 118 associated with a plurality of credit card accounts 202 and debt information 120 associated with a plurality of debtor invoices 204. The credit information 118 for each credit card account 202 may include a respective account number, a respective credit limit, a respective account balance, a reward value as previously described that preferably indicates at least a reward benefit associated for using that particular credit card account, as well as any other credit information deemed pertinent. The debtor invoices 204 may include a vendor identifier, an amount due, a date due, and/or any other information deemed pertinent.

The payor host 12 preferably includes a first subsystem 206 that retrieves the credit information 118 and debt information 120 from the storage 116 and allocates at least a portion of an amount due for one of the vendors to a selected credit card account based on the reward value associated with the selected credit card account. The payor host 12 may also include a second subsystem 208 capable of selectively updating the reward values associated with the respective credit card accounts 202 stored in storage 116.

In one embodiment of the disclosed payor host 12, the reward value associated with each credit card account may be fixed. For example, a relatively simple embodiment of the disclosed payor host 12 may use a reward value that is a ranking or value merely reflecting the incremental movement towards a reward for each dollar spent on the account. That is to say, if a credit card offers a reward of a round trip airline ticket upon the accumulation of a certain number “n” of points and “x” number of points are earned for each dollar charged to the card, a reward value might simply be the ratio of “x” divided by “n” which is the benefit gained toward a chosen reward for each dollar charged to the card.

The embodiment just described is particularly appropriate if a business is interested in a single reward type (e.g., airline tickets) and therefore includes credit information for only credit card accounts that offer airline miles. This embodiment might be preferred, for example, by a business or government agency whose employees often fly on business trips. By allocating vendor debts to selected credit card accounts in a manner that achieves free airline tickets as rapidly as possible, such a business or agency would achieve a substantial cost savings than if the debts were allocated randomly among several credit card accounts.

The aforementioned embodiment may not always be optimal, however. Some businesses might desire to collect more than one type reward or may merely be interested in achieving the most cost benefit among a number of types of rewards cards, and relatively indifferent towards the particular reward earned. Assume, for example, that a business has a plurality of rewards cards representative of more than one type reward (e.g. some airline rewards cards, some hotel rewards cards, or several cards that each permit points to be redeemed for a variety of types of rewards). In that instance, the reward value might reflect the incremental monetary reward benefit for each dollar charged to the account. For example, using the parameters “x”, and “n” as previously described, the reward value could be the dollar value “d” of the reward associated with the particular credit card account multiplied by the ratio of “x” divided by “n.” If a given credit card account has more than one reward being redeemable, each reward will have an associated dollar value, an associated number of points required to redeem that reward, and an associated number of points earned for each dollar charged on the card, and thus the reward value could be the highest product of “d” multiplied by “x” and divided by “n.” This particular embodiment might be appropriate for a sole proprietorship or family business who selects the types of rewards the owners are likely to use the most and seek to distribute their payments among their business credit cards in a manner that achieves the highest cost benefit.

Still other types of reward values may be appropriate. A given reward card may offer double or triple points if charges are made to a specific vendor. If so, the reward value will preferably include a value or identifier for each vendor account or for groups of vendor accounts so that the first subsystem may allocate amounts due to certain preferred vendors to that account. Similarly, some employers may offer employee benefits in the form of vacation packages where it is desirable to achieve rewards in groups or packages i.e., a round trip airline ticket, a hotel reservation, and a car rental. In that instance, the “reward value” associated with each credit card account could comprise two values, one that indicates the type of reward in the selected package, and a second that represents the incremental movement toward the reward for each dollar charged to the account, where the first subsystem allocates vendor debts among types of rewards cards in a manner that achieves rewards in the selected packages.

As should be evident, many types of reward values are compatible with the present system and will largely depend upon the individual desires of the users. For that reason, the payor host 12 may include a third subsystem 210 that permits a user to select one of a plurality of rewards goals. For example, the payor host 12 may offer the user a choice of reward goals, where each reward goal is associated with one of the aforementioned reward values. Thus a particular embodiment of the payor host 12 may permit a user to select a reward goal that either maximizes the incremental movement towards a preferred reward, maximizes the incremental benefit value of monthly charges, or achieves rewards in packages. Other options are easily envisioned. A user may be given a choice to equalize payments among all available credit cards as well as a choice maximize the float i.e. the time between charging an amount to the credit card and the due date for the next credit card installment.

FIG. 3C shows an exemplary third subsystem sufficiently flexible to permit a user to establish a customized reward goal. Many reward programs are associated with a number of credit cards. For example, the United Mileage Plus program may be associated with quite a few different credit cards, yet points earned for purchases made on several respective individual cards may be combined towards a reward of a round trip airline ticket. To take advantage of this feature, a user of the disclosed system may have a credit card set 220 comprising one or more individual cards 1-k each individual card associated with one reward type, e.g. United Mileage Plus or other airline mileage program. The user may also have additional credit card sets 222, 224, and 226 each of which also comprises one or more individual cards associated with one reward type. The third subsystem 210 may then permit the user to establish goal priorities 221, 223, 225, and 227 and assign reward values to each individual card to maximize the achievement of the selected reward goal.

As one example, assume that a particular user wishes to establish an employee benefit program in which vacation packages are to be accumulated comprising a round trip airline ticket, a hotel reservation, and a car rental. In that instance, goal priority 221 could be “airline tickets”, goal priority 223 could be “hotel reservations” and goal priority 225 could be “automobile rentals.” If the user has more than one credit card account associated with any one of the chosen rewards e.g., more than one Mileage Plus card, the rewards values for those cards may be ranked primarily by their goal priority and secondarily by the incremental benefit achieved for a dollar charged on the card. Thus in operation, vendor accounts are first charged to the credit card set associated with goal priority 221 until a respective reward benefit e.g., a round trip airline ticket, is achieved. Because the credit card set 220 may include more than one credit card, the rewards points of which are cumulative, the reward benefit associated with the goal priority 221 may be achieved more quickly for two reasons. First, each credit card in the credit card set 220 may be prioritized so that vendor debts are first allocated to the card that achieves the highest incremental benefit per dollar charged. Second, once the credit limit for the highest priority card in credit card set 220 is reached, vendor debts may be allocated to other cards in the credit card set 220 rather than a card that earns points to a different reward.

Once the reward associated with the goal priority 221 is achieved, vendor accounts are charged to the card or cards associated with the second priority goal until that reward benefit is achieved, and so forth until a vacation package is attained and the process may begin anew to achieve additional vacation packages.

The exemplary third subsystem shown in FIG. 3C may also be used to achieve a variety of other types of reward goals. For example, if a user simply wants to accumulate round trip airline tickets, each of the credit card sets 220, 222, 224, and 226 may pertain to a given airline mileage reward program, e.g. United, Delta, Northwest, etc. Alternatively, if the user wishes to maximize the monetary value of the rewards, credit card set 220 associated with the highest priority goal would be the credit card set offering the highest value reward per dollar charged and so forth.

The exemplary third subsystem shown in FIG. 3C may also be modified to accommodate vendors who only accept certain types of credit cards. Thus if a vendor only accepts American Express, and no credit card in the credit card set 220 is an American Express card, the debt for that vendor may be allocated to a credit card set that includes an American Express card. Furthermore, the exemplary third subsystem shown in FIG. 3C is illustrative only, and may be modified as desired or replaced with any other appropriate subsystem that permits a user to select or otherwise implement a desired reward goal.

The payor host 12 preferably has a first subsystem 206 that is as flexible as possible. Thus the first subsystem 206 may permit a user to adjust any amount allocated to a particular credit card. While some embodiments of the first subsystem 206 may simply permit a single vendor invoice to be charged to a single credit card account, other embodiments may permit a monthly vendor invoice to be split among multiple credit card accounts. Preferably, the payor host 12 includes a first subsystem 206 that permits multiple vendor invoices to be charged to a single credit card in any given month.

The payor host 12 preferably includes a connection to the Internet to permit the second subsystem 208 to periodically update the reward values associated with the credit information for each of the plurality of credit card accounts stored in the storage 116. Typically, the second subsystem 208 will include a number of Internet addresses at which current reward information may be available. Alternatively, there are a number of automated web searching tools available e.g., web crawlers that may easily collect the necessary data to update the reward information.

The payor host 12 may also include a fourth subsystem 212 capable of generating a credit card authorization with which a vendor invoice or a portion of a vendor invoice is charged to a particular credit card account. Typically, credit card authorizations are paper transactions to be submitted by the vendor to it's acquiring bank. However, the payor host 12 is preferably capable of generating a transaction record, using the fourth subsystem 212, that permits the payor to submit the transaction to the acquiring bank 20 on behalf of the vendor. For example, the fourth subsystem 212 may use a printer 132 to print a paper copy of an authorization, which includes the vendor's merchant ID number, to be sent to the acquiring bank 20 or any appropriate intermediary, by any appropriate means, e.g. mail, fax, e-mail etc. Alternatively, the paper transaction record could be sent to the vendor, or the fourth subsystem 212 may generate an electronic authorization by which amounts due are charged to a credit card account by the system 10 without submission of a form to the vendor. In that instance, amounts due to a vendor are paid in a manner that is transparent to the vendor, such that the vendor need not be given any personal credit information, such as a credit card number or expiration date in order for a payment to be submitted. This option, is obviously more secure.

FIG. 3B shows a payor host 12 that is self-contained i.e., it is entirely embodied in the local computing device 112. It may be preferable to also include a remote computing device 114 as depicted in FIG. 3D. In that instance, the local computing device 112 may include the storage 116 necessary to store the aforementioned credit information and debt information, and include the first subsystem 206 that allocates amounts due among selected credit card accounts, the third 210 subsystem that optionally permits a user to select a choice from a plurality of reward goals, and the fourth subsystem 212 that generates a credit authorization, either paper or electronic. The remote computing device may include the second subsystem 208 that selectively updates the reward values. In this embodiment, the remote computing device 114, which may be a remote server, includes storage that stores data pertaining to the businesses using the disclosed payor host 12, the credit card accounts used by each of those businesses, and the reward values associated with each of the credit card accounts used, where the reward values for a given credit card may be unique to a given business, as mentioned previously. The remote server periodically updates the stored reward information. If any given reward information changes, businesses whose payor host 12 uses that reward information or reward value are sent a notice or alert by e-mail or otherwise indicating that there are recent updates. When an affected business next uses the payor host 12, the alert is received and the user may selectively connect to the remote server to have the appropriate reward values updated prior to the time the first subsystem begins to allocate amounts due on vendor's invoices.

Existing automated accounting systems do not provide for automated payment of vendor invoices using credit cards. Typically, if a user elects to pay a vendor using a credit card, the user must first pay the debt using a credit card and afterwards manually enter the transaction into the accounting system, flagging the debt as being paid by credit card, and sometimes will be given the option of entering further details about the transaction, such as the credit card used, payment due date, etc., into a comment field. However, this comment field does not provide an effective means of searching, e.g., requesting that the accounting system display all vendor invoices paid with a given credit card.

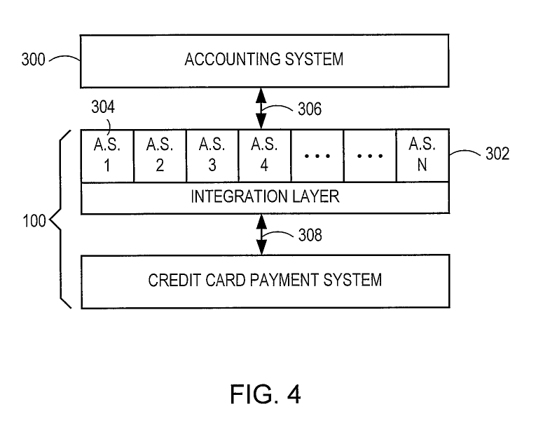

The disclosed payor host 12 conveniently permits the automated payment of vendor invoices with credit cards. Furthermore, the payor host 12 does so in a manner that permits credit card payments to be searched by any desired parameter. The payor host 12 may be used with an existing stand alone accounting system, such as one provided by Great Plains, Quickbooks, MA590, Timberline, or ACCPAC, etc. Referring to FIG. 4, the payor host 12 may include an integration layer 302 comprising one or more integration modules 304 that each permit the payor host 12 to communicate one of a number of available accounting systems 300. The disclosed payor host 12 preferably uses an appropriate integration module 304 to extract vendor data, including vendor names, amounts due, and dates due from the particular accounting system 300 used by the user. The disclosed payor host 12 then allocates the retrieved amounts due among the credit card accounts stored in the system 10 and preferably generates payment authorizations for payment of the retrieved debts using the stored credit card accounts.

Preferably, this process is done in a manner that is transparent to the accounting system 300. The disclosed payor host 12 then flags the paid vendor debts in the accounting system as being paid.

The disclosed payor host 12 may preferably be searchable by any one or more desired parameters, such as credit card account, date due, date paid, reward benefit offered, etc. Furthermore, the disclosed payor host 12 is preferably independent from the accounting system 300 such that implementation of the disclosed payor host 12 requires no modification to the accounting system, and removal, detachment, or disassociation of the payor host 12 from the accounting system 300 leaves the accounting system 300 unaltered.

Preferably, the integration layer 302 includes a sufficient number of integration modules 304 to ensure compatibility with a variety of existing accounting systems. Furthermore, the disclosed payor host 12 may be periodically updated to add or update integration modules 304, as needed. The communication channels 306 and 308 between the integration layer 302 and the accounting system 300 and the credit card system 310 respectively may be APIs if desired.

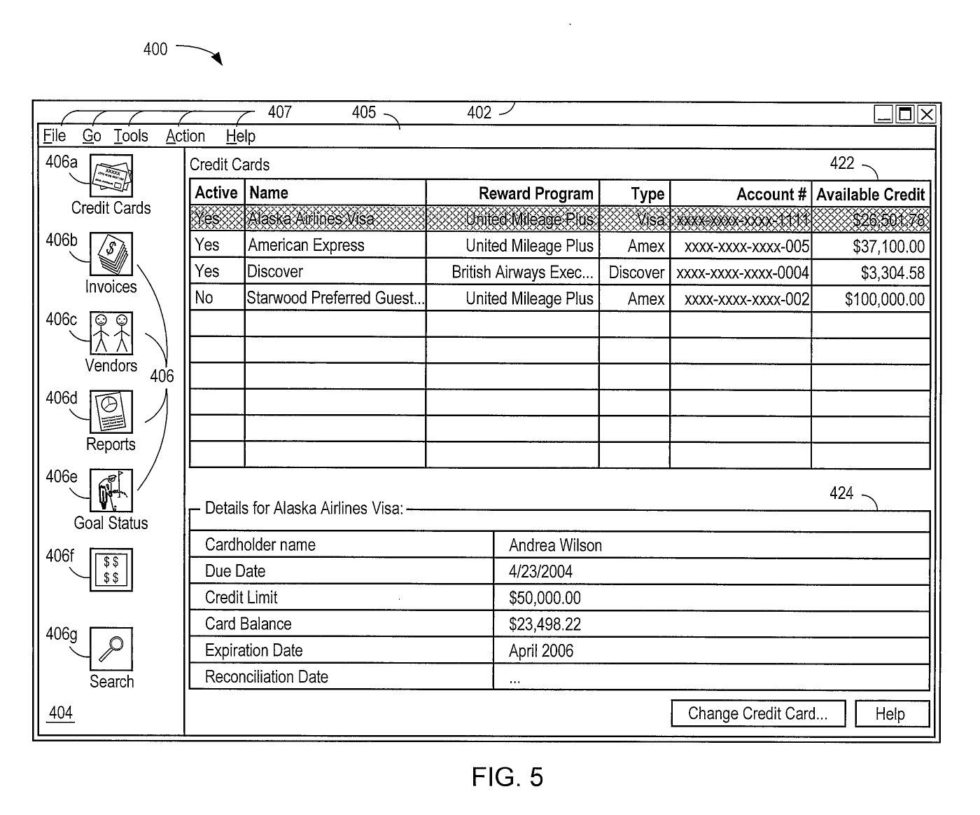

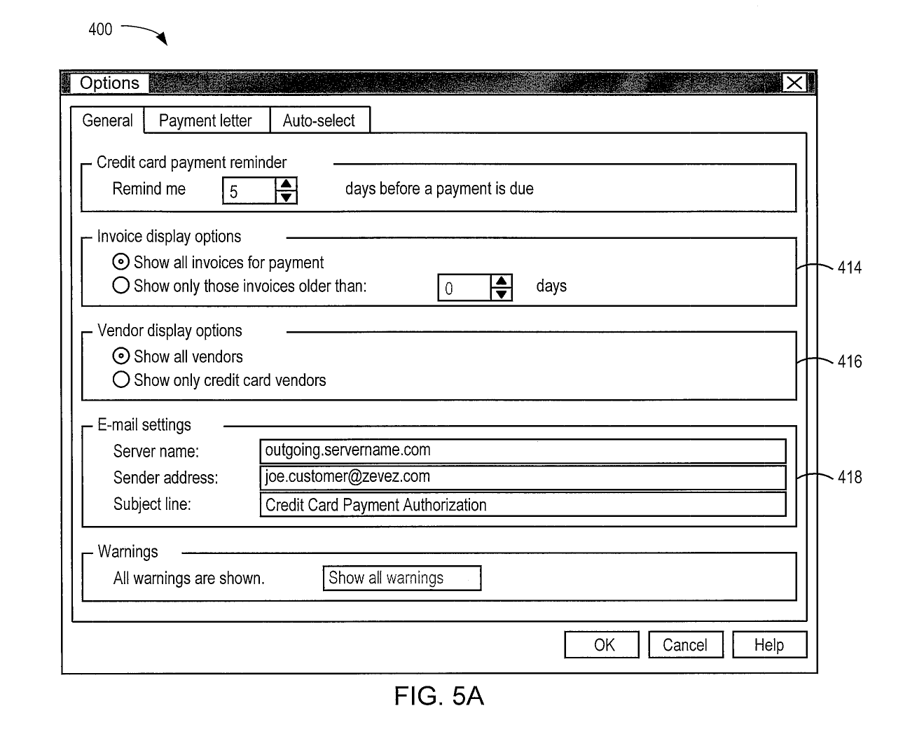

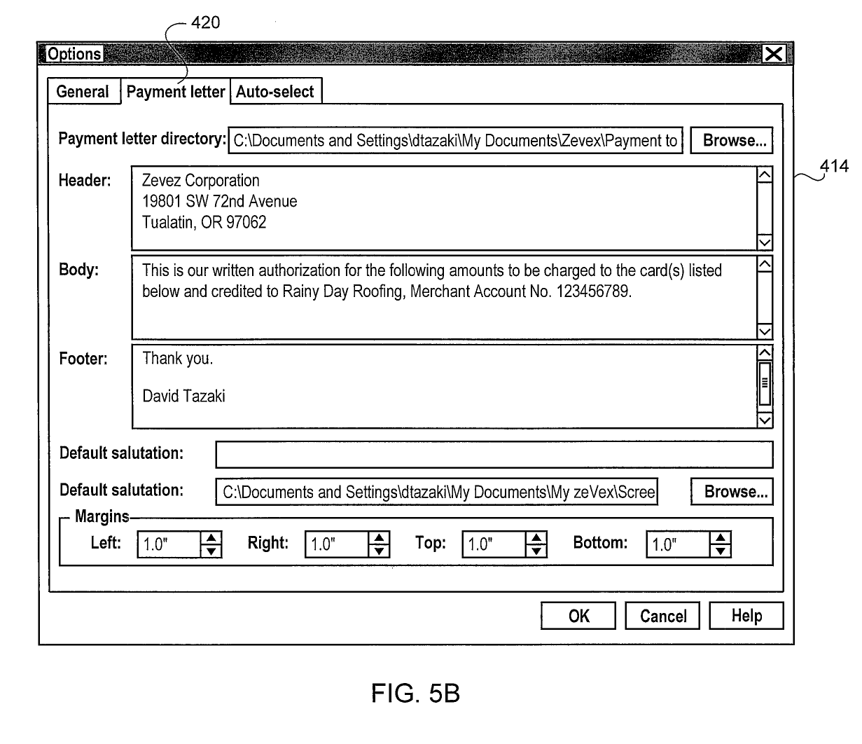

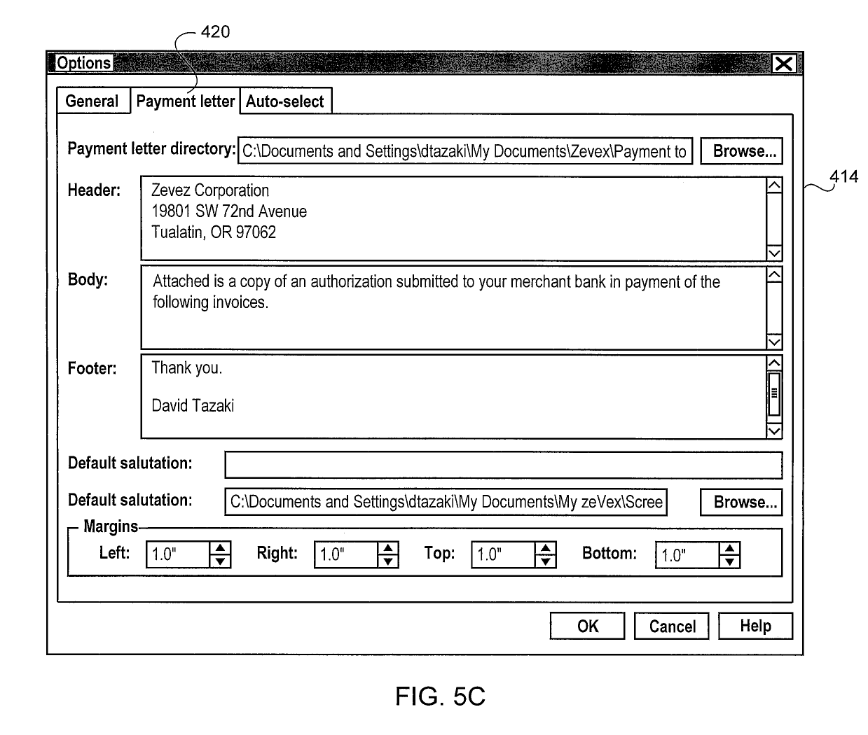

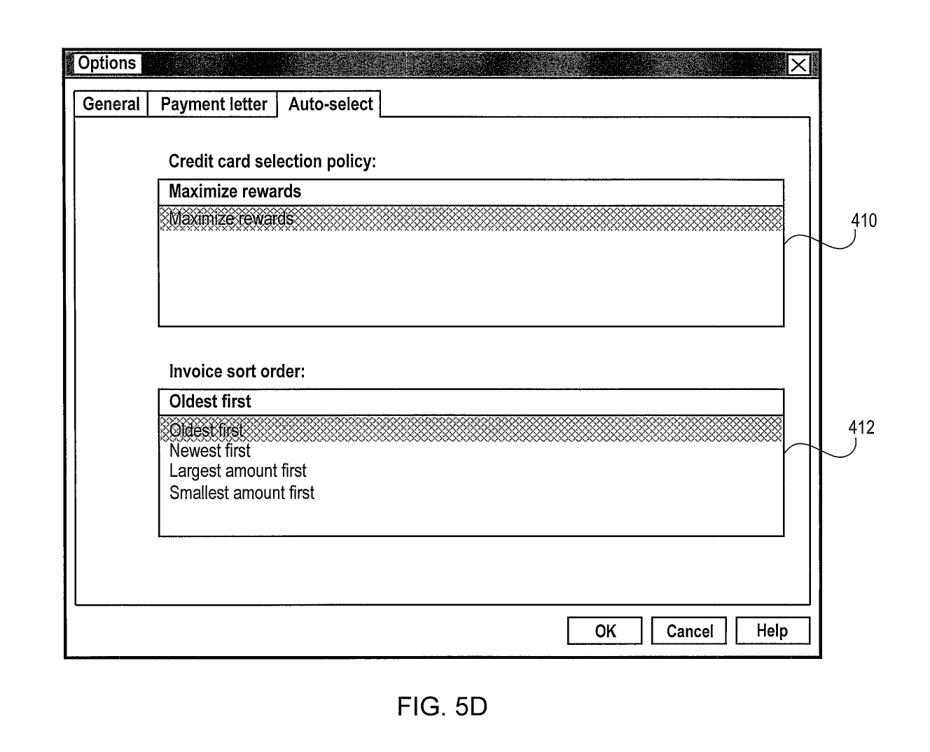

FIGS. 5-9 show one preferred computer program 400 that implements the disclosed system. The computer program 400 may present a user with a display 402 having fields 404 and 405 with icons 406 and/or menus 407 by which the user may navigate through the program 400. For example, the display 402 may include several display options, including “credit cards” 406a, “invoices” 406b, “vendors” 406c, “reports” 406d, “goal status” 406e, “redeem rewards” 406f, and “search” 406g, as well as icons permitting the selection of each of the display options. Each of the display options 406a-406g will be described in further detail below. Also, the field 405 may be a menu bar 4 providing additional navigation options by selecting the appropriate display options. The member 405 may be in the form of a standard Windows menu bar, having separate menus for “file,” “tools,” “help,” etc., or any other desired menu. Within each menu may be a submenu by which a user may take a selected action.

Upon initial start up, a user may preferably enter an options dialog through the tools menu item on the menu bar 407. Referring to FIGS. 5a through 5c, the options display may be used to set any one of a number of desired parameters. For example, a user may be able to choose from a number of rewards options within a dialog block 410. Such options may include, but are not limited to, “maximize rewards”, “distribute invoices evenly”, and “maximize float.” Each of these options has been previously described. A user may also be able to select the order in which invoices are sorted from the dialog block 412; invoice display options from dialog block 414, and vendor display options from dialog block 416. The options menu may also be used to set the e-mail address settings of the user through the dialog box 418, if the system is configured to send and receive e-mail. Furthermore, the options dialog may include a payment letter template 420 that is used by the payor host 12 to generate payment authorizations.

Referring to FIG. 5B, for example, the payment letter may be generated from a template intended to submit a written authorization to the acquiring bank 20 of a merchant being paid by the relevant transaction. As noted earlier, such a written payment authorization may be needed, or desired, irrespective of whether the payor host 12 automatically submitted an electronic record of the captured transaction, because the written authorization may be requested by the merchant so as to qualify for reduced interchange fees. Alternatively, if the payment method is by check, and an electronic authorization has been submitted by the payor through ACH or ECHO, as previously described, a written authorization may be unnecessary.

Referring to FIG. 5C, the payment letter may be generated from a template intended to send the merchant a verification that payment has been submitted to the merchant's acquiring bank. That letter may accompany a copy of the written authorization submitted to the acquiring bank, or a copy of an electronically received confirmation of payment, which does not include sensitive credit card information, but instead merely information about the amount of payment, an identifier of the merchant account into which payment was deposited, and any confirmation number received from the acquiring bank or an intermediary, such as a batch ID, authorization code, etc.

Referring to FIG. 5, the display 402 may be set to the credit card display option 406a by default. The display option 406a includes a window 422 that shows each of the credit card accounts to be used by the payor host 12 to pay vendor invoices. The window 422 may indicate, for each credit card account displayed, the name of the account, the status of the account (active or inactive), the reward program associated with the account, the type of credit card (Visa, Discover, etc.), the account number, and the amount of available credit. Each of the credit card accounts displayed in the window 422 may be highlighted by the user in order to display further information about that credit card account in a second display 424. This additional information may include the cardholder name, the due date of the next payment on the credit card, the credit limit on the credit card, the credit card balance, and the expiration date of the credit card.

The payor host 12 may store information pertaining to more credit card accounts than those displayed in the window 422. For example, a particular rewards goal selected by the user in the options dialog may cause the payor host 12 to choose selected credit card accounts to pay vendor invoices based on the respective reward values associated with the selected credit card accounts. The display option 406a may permit a user to override the system's selection of a given credit card account, using a button 426, thereby replacing a highlighted credit card account with a different credit card account.

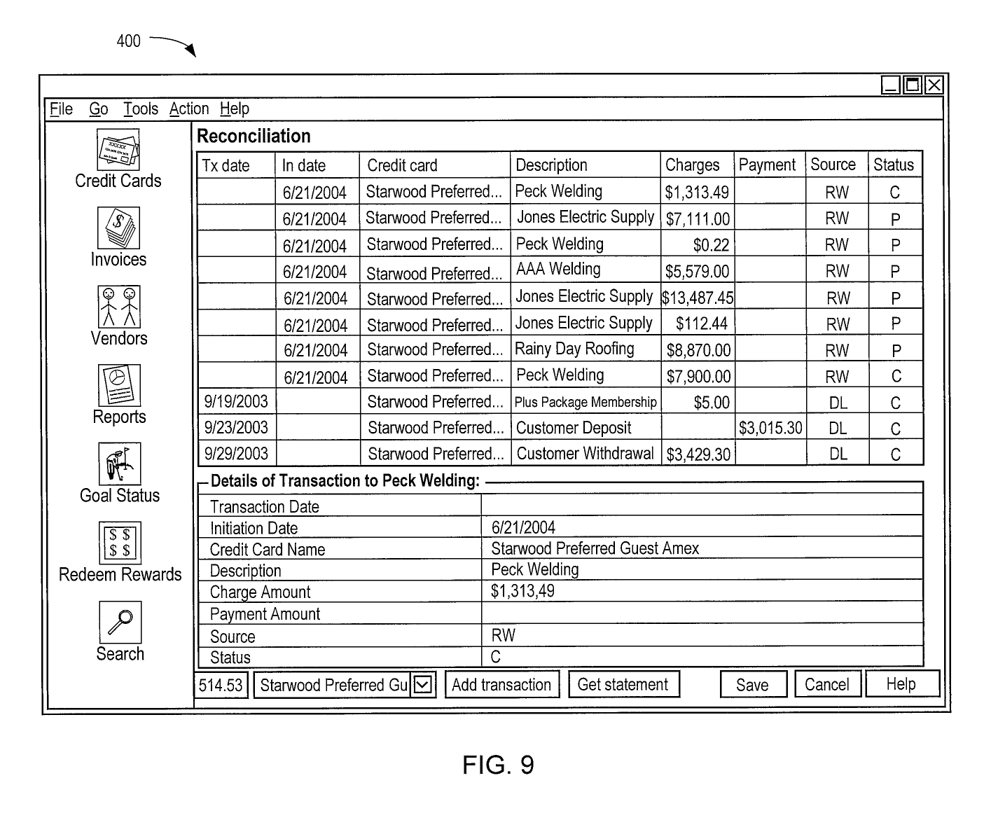

The payor host 12 may also permit a user to reconcile a credit card account from the display option 406a if the payor host 12 has an Internet connection. Referring to FIG. 9, for example, selection of a reconciliation button 428 may bring up a display 430 using information received from a credit card company over the Internet. The display 430 may include the transaction information posted to the account. Using the display 430, a user may add a recent transaction not yet posted so that the payor host 12 is using the correct amount of available credit for the selected credit card account. The display 30 may also be used to save the modified reconciliation data and/or print a reconciliation statement.

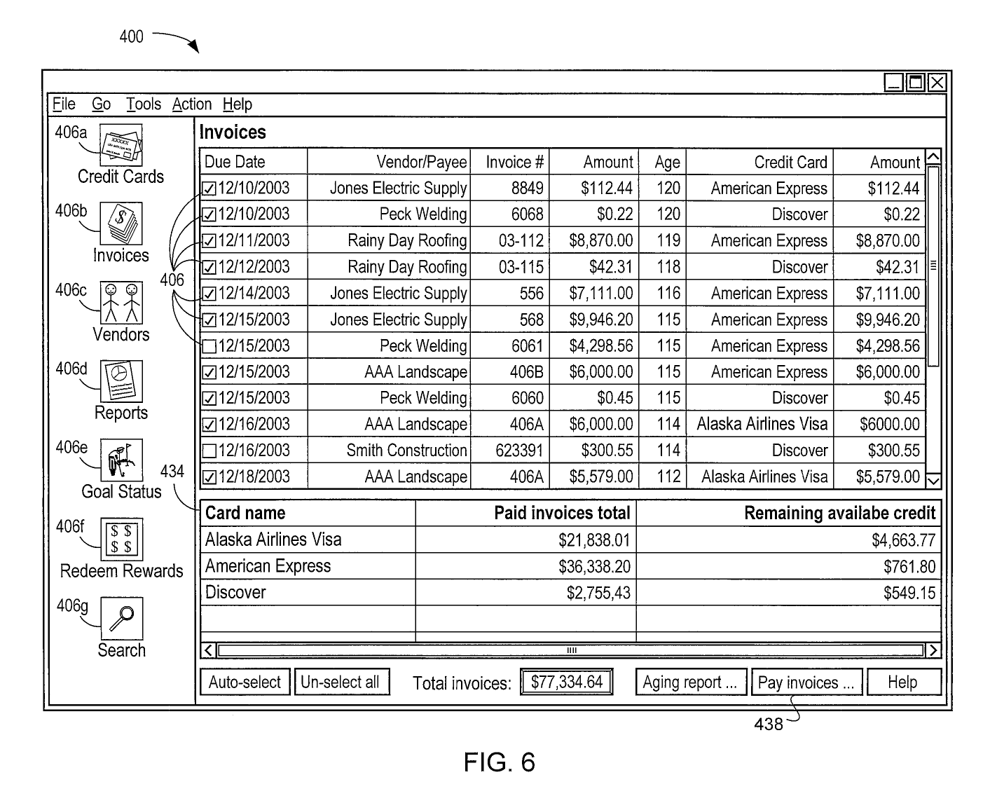

Referring to FIG. 6, the display option 406b may show a list of the vendor invoices to be paid by the payor host 12 using the credit card accounts displayed in display option 406a. The user may select or unselect individual invoices to be paid by checking selected boxes 436. Alternatively, the user may have the system automatically select invoices to be paid based upon the available credit of the credit card account shown in the display option 406a and the invoice sort order selected in the options dialog. The user may also obtain an aging report from the display option 406b. A window 434 may show the credit card accounts used by the payor host 12 to pay the invoices selected by the user, the amount charged to each of those accounts, and the remaining credit available on each of those credit card accounts. Once the user has selected all the invoices to be paid by the payor host 12, the user may select a button 438 that generates respective transaction authorizations, which each can be either paper authorizations only, electronic authorizations only, or a combination of the two, along with any necessary confirmation letters to be sent to the respective vendors. The display option 406b shown in FIG. 6 assumes the vendor information has been extracted from a stand alone-accounting program. Alternatively, the payor host 12 may be configured to add vendors from a database using a separate window, dialog or button.

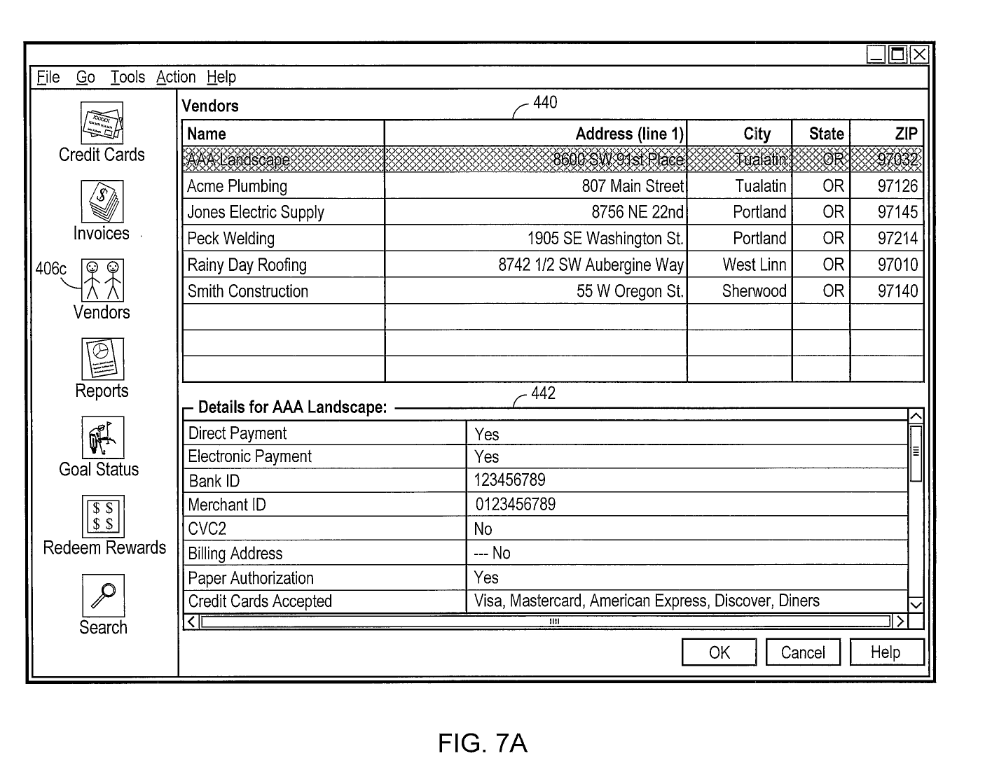

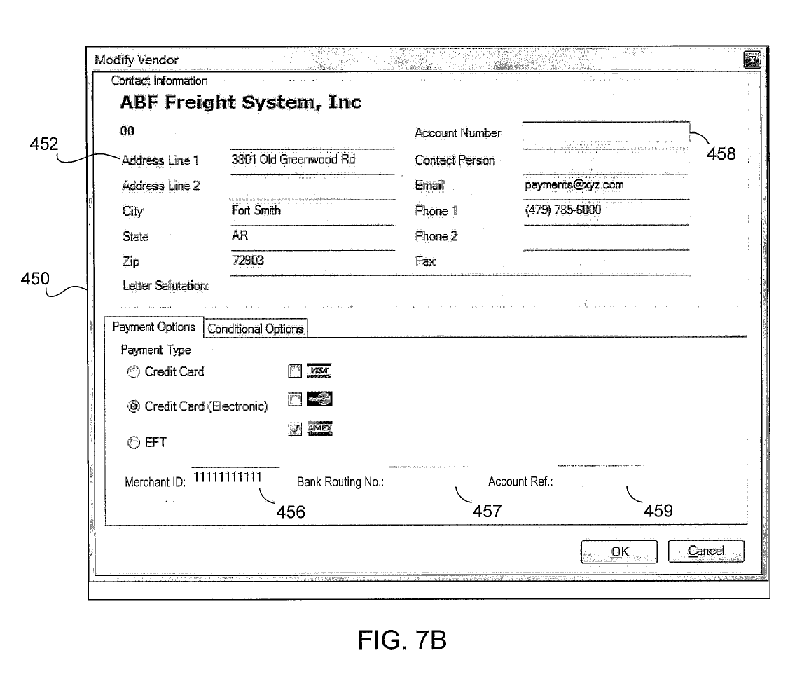

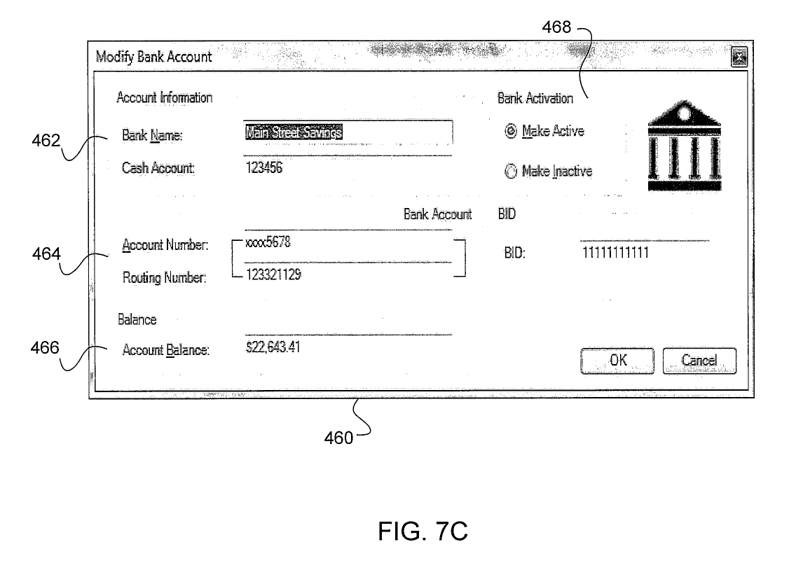

Referring to FIG. 7A, display option 406c may show a list of vendors for which the system 10 stores debt information, i.e., invoices, in a window 440. A window 442 may be used to show additional information specific to a highlighted vendor including the credit cards accepted, how the vendor should be contacted etc. Preferably, the window 442 shows information about whether a vendor allows payments to be submitted on their behalf, and if so, whether electronically and what information needs to be transmitted, e.g. CVV2 code, paper authorization etc. More preferably, the window 442 is filtered such that inapplicable information is left out. For example, if a first field indicates that the merchant does not allow payments to be made directly to it's acquiring bank on it's behalf, there would be no need to show a field for an ABA identification of the merchant's bank, or the merchant ID number. The information in the data fields of the window 442 is used to automatically generate the authorizations, electronic or otherwise, as well as select an appropriate confirmation template, etc.

Referring to FIG. 7B, information corresponding to vendors listed in window 440 may be entered or edited in display 450. For example, biographical data may be input in screen region 452 while an account identifier for the vendor may be entered in field 458 so that one vendor may be automatically distinguished from another. Also, payment methods permitted or preferred for a particular vendor may be entered in display region 454, such as by credit card or electronic funds transfer. If an electronic credit card payment is authorized, the merchant ID number may be entered in field 456. If an electronic funds transfer payment is authorized, the vendor's bank routing number and deposit account identifier may be entered in fields 457 and 459, respectively. It should be understood that the account reference number 458 need not be an actual deposit account number, but instead simply a unique identifier by which the vendor's bank may associate with the vendor's deposit account at that bank.

Referring to FIG. 7C, a display 460 may allow for editing of information related to the account from which funds electronically transferred are withdrawn. This information includes a bank name and/or other identifier, edited in field 462, account and routing numbers edited in field 464, and an account balance edited in field 466. Preferably, the account balance is automatically updated by the payor host 12, either as payments are made by electronic funds transfer, by checks linked to that deposit account etc. Also, the payor host 12 may include a network connection to a server at the bank or other deposit institution to regularly update the account balance shown.

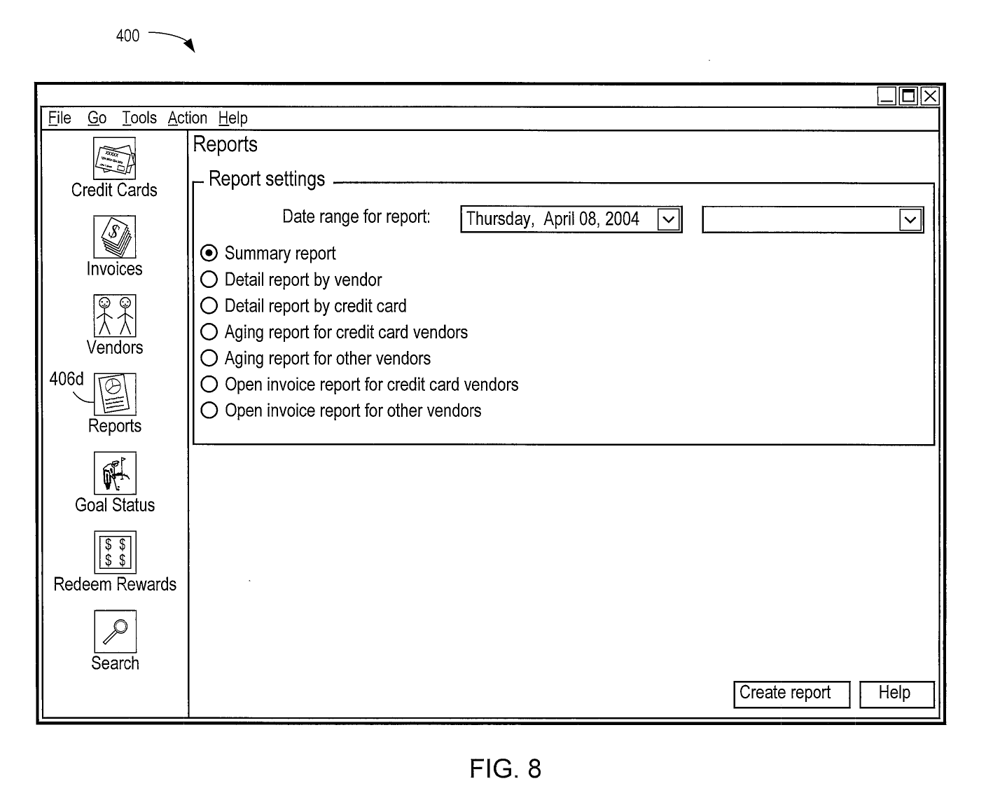

Referring to FIG. 8, a user may obtain any one of a number of reports using the display option 406d. The display option 406d may provide a choice of a summary report, a detail report by either vendor or credit card, aging reports or open invoice reports, or any other desired report. The display option 406d may also allow a user to select the date range for the chosen report.

The system just disclosed included a payor host 12 that implemented POS software capable of submitting a captured credit transaction to a merchant's acquiring bank, and did so under the rubric of a payment system that jointly processed multiple payments to multiple vendors of the payor, accumulated on a monthly basis, for example. Many variations on this system are possible. In particular, it is desirable to incorporate the foregoing embodiments into systems that allow ad-hoc, individual purchases from merchants in near-real time, as is possible by visiting a vendor's web site and purchasing goods that are shipped daily, but instead without submitting credit card information to the merchant.

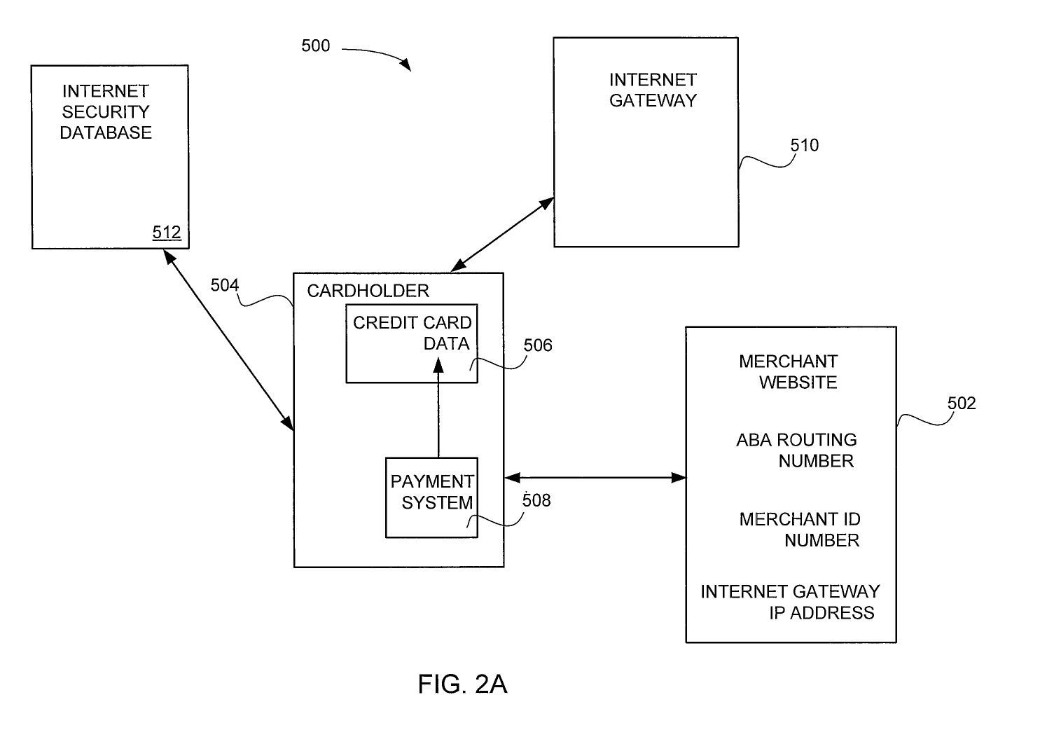

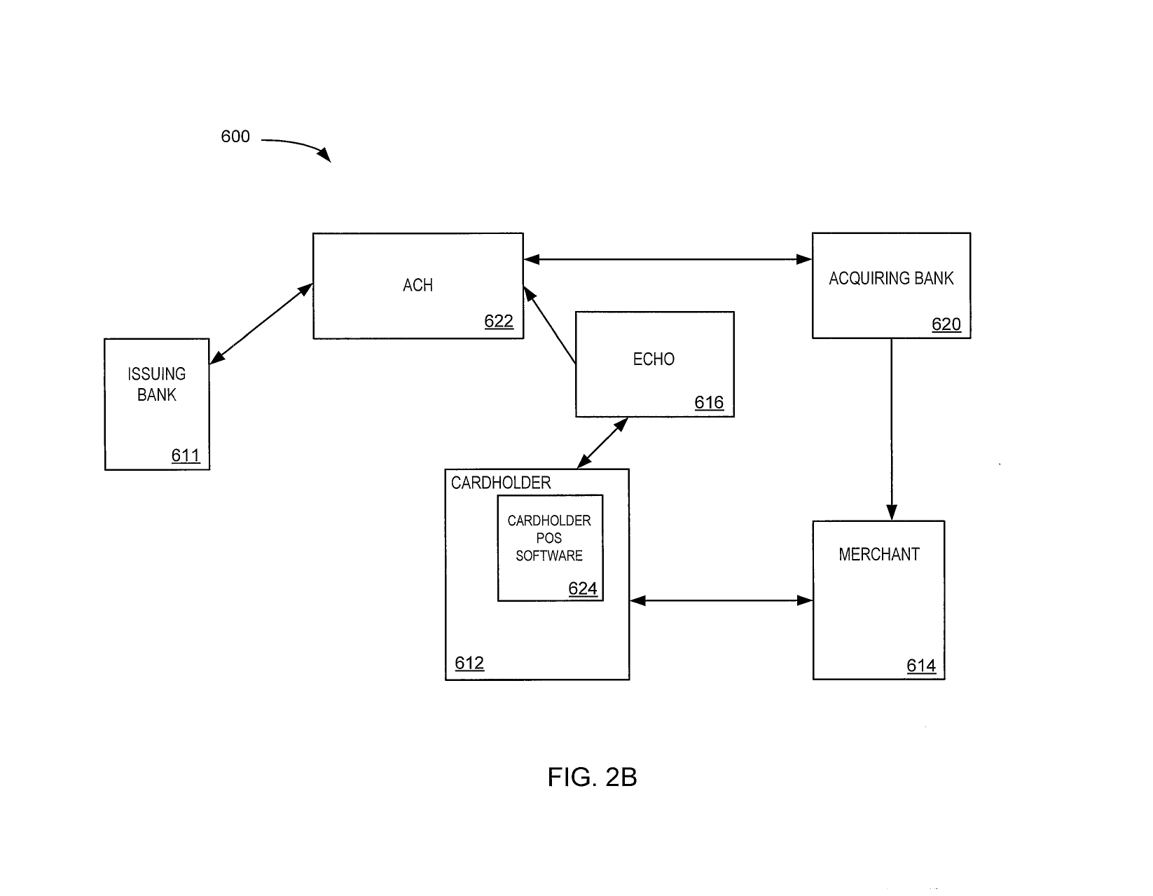

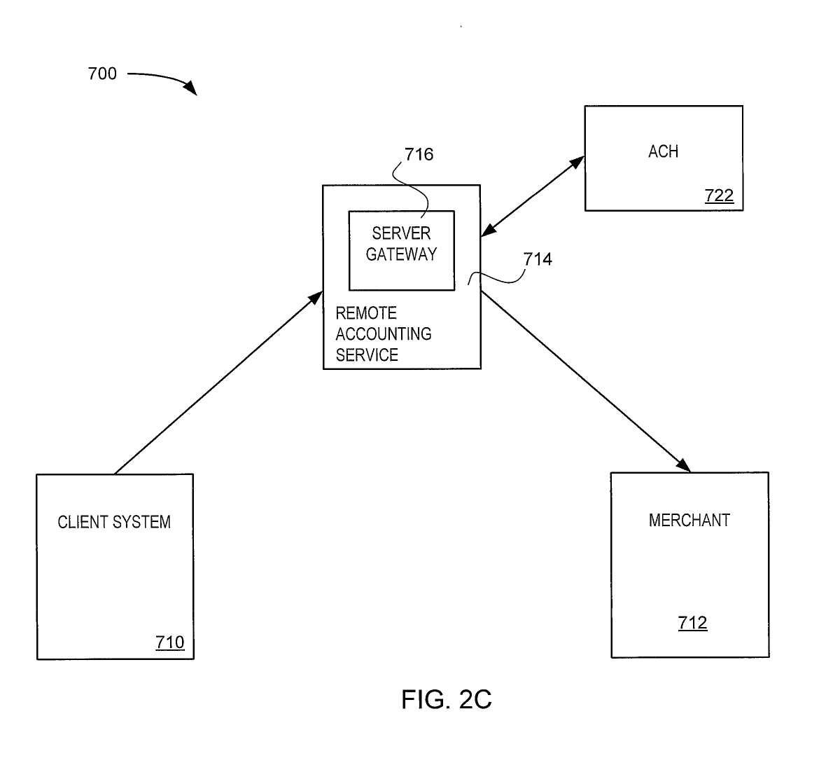

As one example, and referring to FIG. 2A, a system 500 intended for ad hoc, online payments to Internet vendors may include a cardholder host 504 that includes a first storage 506 to store credit card information for a plurality of credit cards possessed by the cardholder. This information may include all credit card information needed to electronically process a transaction from that credit card, e.g. billing address, shipping address, CVV2 code, etc. The cardholder host 504 also includes a payment processing system 508 capable of interacting with a web site 502 of a merchant to extract merchant information needed to complete the transaction. As one example, the information may include the merchant account identifier along with the ABA identifier for the merchant's acquiring bank. The information may also include an IP address of an Internet Gateway used by the merchant to process the electronic transactions that the merchant captures itself. In this manner, the cardholder host 504 may submit transactions to the Internet Gateway of the merchant, which are batched, confirmed, etc with all other transactions of the merchant, but without divulging any credit card information to the merchant. Moreover, such a system 500 may be incorporated directly into a web browser, if desired.

Preferably, if receiving IP addresses of a merchant's Internet Gateway, the system 500 will include access to a security database 512 that compiles a list of all authentic IP addresses of secure Internet Gateways, and that is periodically updated. In this manner, the system 500 is protected from a fraudulent web site that gives an IP address of an Internet Gateway designed to steal credit cad information, by comparing the received IP address to the list of authentic addresses.

Referring to FIG. 2B, in yet another alternative embodiment, a system 600 may include a cardholder host 612 that, like the embodiment of FIG. 2A, receives respective identifiers of the merchant's bank and the merchant's account from a web site of a merchant, but instead of receiving an IP address of an Internet Gateway, the cardholder host 612 captures the transaction and submits it to ECHO 216, receiving a payment confirmation that can be returned to the merchant's web site 214 to verify the transaction. ECHO submits the transaction through ACH 222, which reconciles the accounts between the issuing bank 211 and the acquiring bank 220.

Referring to FIG. 2C, a cardholder or other payor may have a local computing device 710 that invokes a payment management system like that described with respect to FIGS. 3A-3D, except that payments whose statistics are specified on the client devices 710 are captured and processed by a common Internet Gateway 716 operated by a provider 714 of the payment management system residing on the client systems 710, or an affiliate of the provider 714. The gateway 716 communicates with ACH 722 so as to consummate transactions involving not only credit cards, but check transactions, as well. A client system 710, wishing to make an ad-hoc purchase at a merchant web site 312, may invoke a subroutine that extracts needed merchant account ID information, and purchase order information, and transmits it to the server gateway, where the information can be combined with the cardholder's check or credit card information, so as to submit an ACH transaction. Once submitted, the server gateway 716 transmits payment confirmation and purchase order ID to the merchant web site 712.

The terms and expressions that have been employed in the forgoing specification are used therein as terms of description and not of limitation, and there is no intention in the use of such terms and expressions of excluding equivalence of the features shown and described or portions thereof, it being recognized that the scope of the invention is defined and limited only by the claims that follow.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

1. A system resident on an electronic storage medium that interacts with a computing device to automatically execute instructions of said system, said system comprising:
(a) a first subsystem that jointly processes plural credit card transactions specified by a payor, each transaction specifying independent payments to a respective at least one vendor;
(b) a second subsystem that retrieves a stored identifier for an account of a said at least one vendor; and
(c) a third subsystem that uses said stored identifier to cause payment in said account of said respective at least one vendor.

2. The system of claim 1 where said identifier includes a merchant account number.

3. The system of claim 2 where said identifier includes an identification of a financial institution that administers said account.

4. The system of claim 1 where said payment is made without divulging credit card information to said vendor.

5. The system of claim 1 where said third system interacts with an acquiring bank of said vendor.

6. The system of claim 1 where said third subsystem interacts with ECHO.

7. The system of claim 1 where said third subsystem completes an ACH transaction.

8. The system of claim 1 where said third system obtains an electronic verification of said payment and transmits said verification to said vendor.

9. The system of claim 1 where said third subsystem makes payment of the transaction to said respective at least one vendor electronically.

10. The system of claim 1 where said third subsystem generates a paper authorization for the transaction to said respective at least one vendor.

11. A system resident on an electronic storage medium that interacts with a computing device to automatically execute instructions of said system, said system comprising:
(a) a first subsystem that processes a credit card transaction specified by a payor to a merchant;
(b) a second subsystem that retrieves an identifier for an account of said merchant stored on a web site of said merchant;
(c) a third subsystem that uses said stored identifier to cause electronic payment in said account of said merchant; and
(d) a fourth subsystem that transmits confirmation of said payment to said merchant.

12. The system of claim 11 integrated into a web browser.

13. The system of claim 11 where said identifier includes a merchant account number.

14. The system of claim 13 where said identifier includes an identification of a fmancial institution that administers said account.

15. The system of claim 11 where said payment is made without divulging credit card information to said vendor.

16. A system resident on an electronic storage medium that interacts with a computing device to automatically execute instructions of said system, said system comprising:
(a) a first subsystem that processes a credit card transaction specified by a payor to a merchant;
(b) a second subsystem that retrieves from a web site of said merchant, an identifier for an Internet Gateway that said merchant uses to process electronic credit card payments; and
(c) a third subsystem that uses said gateway to cause electronic payment to said merchant.

17. The system of claim 16 where said identifier is a web address.

18. The system of claim 17 including a fourth subsystem that compares the retrieved said web address to a database of web addresses prior to causing said electronic payment.

19. The system of claim 16 where said second subsystem retrieves a merchant account number from said web site of said merchant,

20. The system of claim 16 where said payment is made without divulging credit card information to said vendor.
